(19) United States
(12) Patent Application Publication
(10) Pub. No.: US 2006/0157313 A1
(43) Pub. Date: Jul. 20, 2006

(54) Line arrangement

(76) Inventors: Frank Schirmeier, Schopfheim (DE); Wolfgang Eiche, Neuenweg (DE)

Correspondence Address: Burton A Amernick;Connolly Bove Lodge & Hutz, 1990 M Street N W, Suite 800, Washington, DC, 20036-3425, US

(21) Appl. No.: 10/343,050

(22) PCT Filed: May 5, 2001
(86) PCT No.: PCT/EP01/05100

§ 371 Date: Jan. 28, 2003

(30) Foreign Application Priority Data
Jul. 31, 2000 (DE) 100 37 362.3

(51) Int. Cl. B60L 9/00

(52) U.S. Cl. 191/10

(57) ABSTRACT

In order to transfer energy in a contactless and inductive manner, a primary circuit comprises two parallel lines (9) along which a vehicle comprising a secondary circuit travels. The two lines forming the primary circuit are arranged in the ground in such a way as to ensure the observation of a given distance in relation to the vehicle. U-shaped holding elements (4) are provided, the centre limb (5) thereof comprising two curved holding limbs (8) between which a line (9) is secured. The outer sides of the holding limbs (6) of the U-shaped holding element (4) are provided with projections extending in the longitudinal direction of the holding elements (4). Said holding elements (4) are placed in a rectangular recess (3) in the ground in a vertically adjustable manner by means of said projections.

The invention relates to a line arrangement according to the preamble of Claim 1.

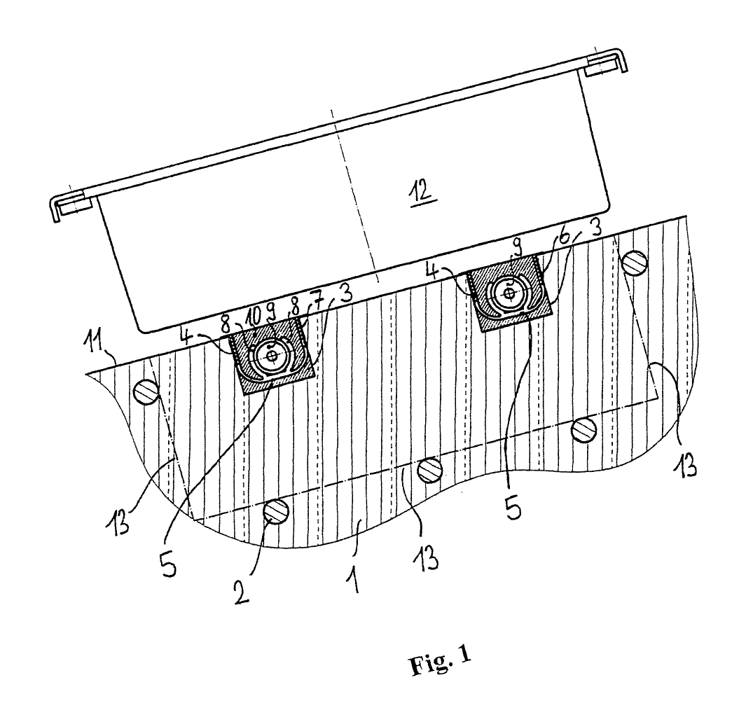

A similar line arrangement is disclosed for example in FIGS. 1 and 10 of EP 0 577 611 B1. The parallel lines forming both primary circuits are attached to a carrier. These lines are engaged in a slot of an E-shaped transformer core on whose center limb is arranged the secondary coil. The above mentioned carrier is attached in the track way of a vehicle which is provided with the secondary circuit. This arrangement ensures that the transformer core, which is equipped with the secondary coil, will be provided with an air gap to both lines forming the primary circuit. The above mentioned arrangement is, however, suitable only for hanging tracks and it represents an obstacle for persons or vehicles which cross the track way.

Should a vehicle be traveling on the ground, both of the lines forming the primary circuit will be placed on the ground. In this case, differing distances along the track way between both lines and the vehicle or the coil of its secondary circuit will be unavoidable. However, the effectiveness of the energy transfer from the primacy circuit to the secondary circuit will be strongly influenced by these differing distances.

DE 197 46 919 A1 discloses a line arrangement for contactless inductive energy transfer, wherein the primary circuit is formed with two parallel lines deployed at a distance between them, and wherein a vehicle, which is provided with a secondary circuit, can be moved along these lines. In addition, this publication indicates that the primary conductor is arranged in a stationary manner in the region of the track way which is close to the surface, and a rectangular primary conductor, accommodated in the ground, is protected with a protective layer, which is magnetically or electrically not conductive and which can also form the ground cover, so that it is mechanically protected.

U.S. Pat. No. 6,073,739 discloses a line arrangement for contactless, inductive energy transfer, wherein the primary circuit is also formed with two parallel lines deployed at a distance between them and wherein a vehicle can be moved along these lines, which is provided with a secondary circuit.

Further, according to this document, the holding parts and the holding limbs are removable and a line can be imbedded between them.

The task at hand is thus to further develop a line arrangement in such a way so as to enable a simple and quick assembly of the lines.

The task is achieved in accordance with the characteristics described in claim 1. Advantageous embodiments can be inferred from the supporting claims.

The embodiments below provide a more detailed explanation of this invention with reference to the figures. These figures indicate:

FIG. 1 shows a cross-sectional view of a first embodiment form indicating a side view of a part of the vehicle in which the secondary circuit is arranged;

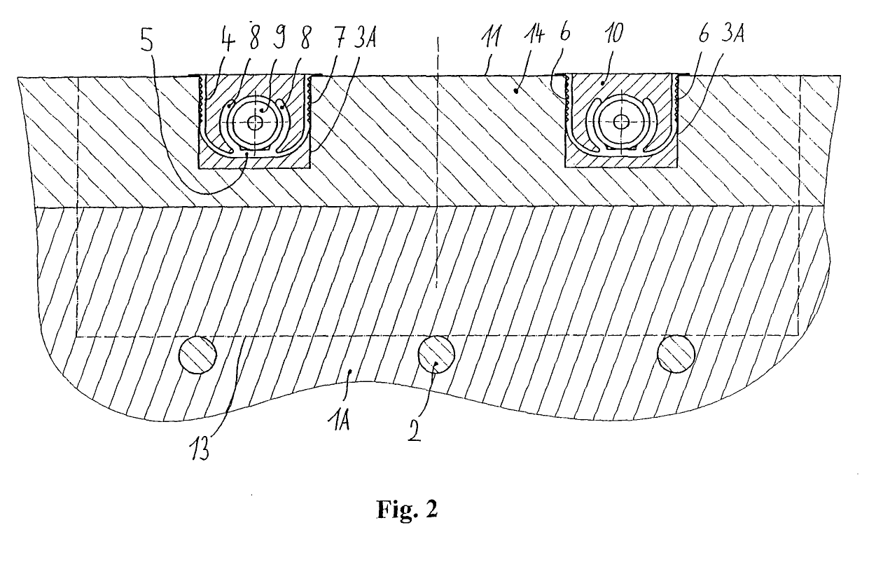

FIG. 2 shows a cross-sectional view of another embodiment form;

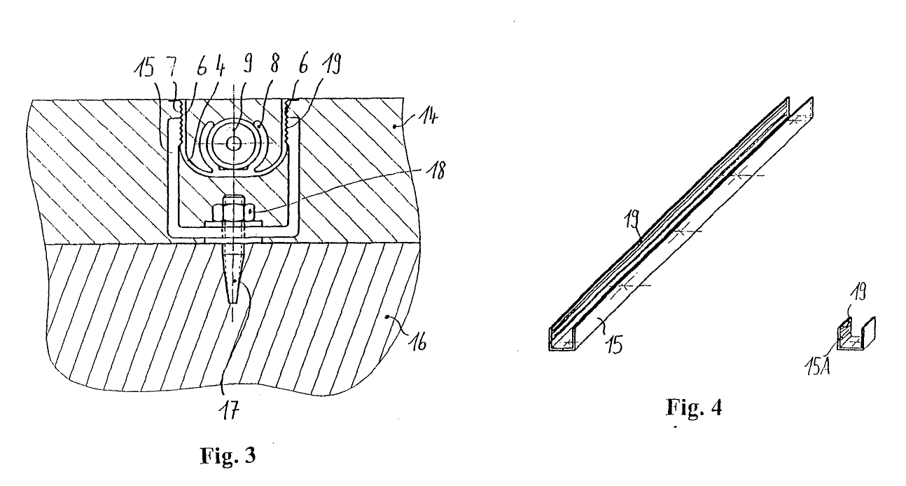

FIG. 3 shows a cross-sectional view of yet another embodiment form, and

FIG. 4 shows a perspective representation of the profile employed in the third embodiment form.

FIG. 1 is an illustration indicating a floor 1 that is made of concrete and provided with reinforcements 2. In this concrete floor 1 are cut two rectangular recesses 3. In these recesses 3 are inserted U-shaped holding parts 4. Each of the holding parts 4 is equipped with a horizontal center limb 5 and two side limbs 6 applying elastic force in the outward direction. Each of the upper ends of the side limb 6 is provided on their outer side with grooves 7, which run in the longitudinal direction of the holding part 4.

On the inner side are formed two curved holding limbs 8 at the center limb 5 of the holding part 4, between which is embedded a line 9. The holding parts 4 are arranged at a distance between them in the recesses 3, for instance with a mutual distance of 250 mm.

After the insertion of the holding parts 4 into the recesses 3, the recesses 3 are filled up with sealing compound 10, for instance with an epoxy resin. Since the holding parts 4 are arranged in a recess 3 at a distance to each other, the space between the side limbs 6 and the space between the center limb 5 and the floor of the recess 3 will be also filled with the sealing compound.

The insertion of the holding parts 4 into the recesses 3 is carried out at an adjusted height, that is to say so that each of the upper edges of the side limbs will be positioned on the same level. This will thus guarantee that the lines 9 are provided with a constant distance to the vehicle part 12 in which the secondary coil is arranged. This distance is independent of the depth of the recesses 3 and independent of the permissible variations displayed by the upper edge 11 of the concrete floor 1. These permissible variations can be for instance +/−5 mm.

The reinforcement 2 of the concrete floor 1 is installed in such a way so that a steel-free zone is formed which is delimited by the lines 13. A minimum distance must be maintained between the lines 9 and a reinforcement bar 2 adjacent thereto, which will depend on the currents in the line.

The embodiment of FIG. 2 differs from the one shown in FIG. 1 in that in the concrete floor 1A is deposited a floor pavement 14, in which are cut both rectangular recesses 3A. The assembly and adjustment is carried out in the same manner as described in the reference provided in FIG. 1.

In the embodiment shown in FIG. 3, the rectangular recess 3B in the floor is provided with a U-shaped profile 15, which is anchored in the floor. The center limb of the profile 15 is provided with holes drilled in it at a distance, and screw bolts 17 are screwed through these holes into the rough floor 16 onto a screw nut 18. The rough floor 16 can be for example a concrete floor. The upper ends of the side limb of the profile 15 are provided on the inner side with projecting parts 19, which are deployed in the axial direction and which are interacting with the projections 7 of the holding parts 4. After the holding parts 4 have been inserted into a profile 15 while being adjusted with respect to the height, a floor pavement 14 is deposited on or into the rough floor. The upper ends of the side limb 6 of the holding parts 4 will determine in this case the dimension for the upper edge of the floor pavement.

The line 9 and the holding part 4 are surrounded by the floor pavement as shown, as was indicated in the reference provided in FIG. 1.

Long profiles 15 are used for inserts running in a straight line, while curves are assembled from short profile pieces 15A.

1. A line arrangement for a contactless inductive transfer of energy, wherein a primary circuit is provided with two parallel lines (9), along which lines (9) can travel a vehicle, provided with a secondary circuit, wherein each of both lines is embedded into a rectangular recess in the floor, filled with a sealing compound that is capable of hardening, characterized by the fact that U-shaped holding parts (4) are provided, whose center limb (5) is equipped with two curved holding limbs (8), between which is embedded a line (9), wherein the outer sides of the side limb (6) of the U-shaped holding parts (4) are equipped with projections (7) deployed in the lengthwise direction of the holding parts (4), with which the holding parts (4) are inserted into each recess (3) at an adjustable height.

2. The line arrangement according to claim 1, characterized by the fact that the rectangular recesses (3) in the floor are cut out from a concrete floor (1), and that a reinforcement (2) of the concrete is deployed at a distance to the recesses (3).

3. The line arrangement according to claim 1, characterized by the fact that the rectangular recesses are cut in the concrete floor (1A) onto which a floor pavement (14) is deposited, and that the reinforcement (2) of the concrete is deployed at a distance to the recesses (3).

4. The line arrangement according to claim 2 or 3, characterized by the fact that a minimum distance is maintained between the lines (9) and the reinforcement (2).

5. The line arrangement according to claim 1 through 4, characterized by the fact that the sealing compound comprises an epoxy resin.

6. The line arrangement according to claim 1, characterized by the fact that both rectangular recesses (3B) in the floor are formed with an anchored, U-shaped profile (15), whose side limb is provided with projecting parts (19), which run in the axial direction and which interact with projections (7) of the holding parts (4).

7. The line arrangement according to claim 6, characterized by the fact that a floor pavement is deposited on the floor in the profiles (15) and in the holding parts (4).
